(19) United States
(12) Patent Application Publication
(10) Pub. No.: US 2014/0337296 A1
(43) Pub. Date: Nov. 13, 2014

(54) TECHNIQUES TO RECOVER FILES IN A STORAGE NETWORK

(71) Applicant: Bryan Knight, Sunnyvale, CA (US)

(72) Inventor: Bryan Knight, Sunnyvale, CA (US)

(21) Appl. No.: 13/891,937

(22) Filed: May 10, 2013

(51) Int. Cl. G06F 11/14

(52) U.S. Cl. CPC G06F 11/1458
USPC 707/674

(57) ABSTRACT

Techniques to recover files in a storage network are described. A recovery manager application may manage file recovery operations for a file sharing application. The recovery manager application may comprise a recovery queue component to receive a request to recover a primary file deleted from a primary storage server. The recovery manager application may also comprise a file location component to locate a secondary file stored in a secondary storage server, the secondary storage server to comprise one of multiple secondary storage servers each configured to utilize a different file duplication technique, the secondary file to comprise a copy of the primary file. The recovery manager application may also comprise a file recovery component to retrieve the secondary file from the secondary storage server, and create a recovered primary file based at least in part on the secondary file. Other embodiments are described and claimed.

### BACKGROUND

Humans and machines are generating data at enormous rates, ranging from website blogs to machine-to-machine (M2M) sensor data to corporate sales information. Network level storage of this information has become increasingly popular for a variety of reasons, not least of which include infinite scalability, low cost, and universal access.

To meet this rising demand, large scale storage networks have been built to warehouse data. A storage network is a dedicated network that provides access to multiple storage devices, such as disk arrays, optical jukeboxes, and other high volume data storage devices. An example of a storage network may include network attached storage (NAS). NAS is computer data storage connected to a computer network providing file-level data access to a heterogeneous group of clients. NAS is often manufactured as a computer appliance, a specialized computer built specifically for storing and serving files, rather than simply a general purpose computer being used for that role. Another example of a storage network may include a storage area network (SAN). A SAN typically provides block-level operations rather than file-level operations, although a SAN may be augmented with a file system to provide file-level access similar to a NAS.

One design challenge in both NAS and SAN storage networks is to offer file services similar to those typically found in a desktop device. For instance, a user may delete a file stored on a personal computer, and afterwards, may desire to recover the deleted file. An operating system for the personal computer may attempt to recover the deleted file using any number of techniques, such as searching a trash folder, archives, backup versions, and other locations within the file hierarchy of the personal computer. File recovery on a storage network, however, is far more complex than attempting to recover a file on a single device, such as a personal computer. It is with respect to these and other considerations that the present improvements are needed.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

In one embodiment, for example, an apparatus may comprise a recovery manager application arranged for execution on a processor circuit to manage file recovery operations for a file sharing application. The recovery manager application may comprise, among other components, a recovery queue component to receive a request to recover a primary file deleted from a primary storage server. The recovery manager application may further include a file location component to locate a secondary file stored in a secondary storage server, the secondary storage server to comprise one of multiple secondary storage servers each configured to utilize a different file duplication technique, the secondary file to comprise a copy of the primary file. The recovery manager application may further include a file recovery component to retrieve the secondary file from the secondary storage server, and create a recovered primary file based at least in part on the secondary file. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of an apparatus.

FIG. 2 illustrates an embodiment of a first operating environment for the apparatus.

FIG. 3 illustrates an embodiment of a second operating environment for the apparatus.

FIG. 4 illustrates an embodiment of a third operating environment for the apparatus.

FIG. 5 illustrates an embodiment of a fourth operating environment for the apparatus.

FIG. 6 illustrates an embodiment of a fifth operating environment for the apparatus.

FIG. 7 illustrates an embodiment of a sixth operating environment for the apparatus.

FIG. 8 illustrates an embodiment of a centralized system for the apparatus.

FIG. 9 illustrates an embodiment of a distributed system for the apparatus.

FIG. 10 illustrates an embodiment of a storage network.

FIG. 11 illustrates an embodiment of a first logic flow.

FIG. 12 illustrates an embodiment of a second logic flow.

FIG. 13 illustrates an embodiment of a third logic flow.

FIG. 14 illustrates an embodiment of a storage medium.

FIG. 15 illustrates an embodiment of a computing architecture.

FIG. 16 illustrates an embodiment of a communications architecture.

### DETAILED DESCRIPTION

Various embodiments are generally directed to improvements for a storage network. Some embodiments are particularly directed to improved techniques to recover files in a storage network that includes heterogeneous storage devices each using a different file duplication technique.

Conventional file recovery techniques are typically limited to locating and recovering data stored on a single device. In a storage network, however, file recovery operations may involve traversing huge numbers of file servers, sifting through dense volumes of data, and interoperating with a myriad number of file storage technologies. Therefore conventional file recovery techniques are not suitable for a storage network.

Embodiments attempt to solve these and other problems by implementing a recovery manager application specifically designed to work with heterogeneous storage devices and storage networks. The recovery manager application may interoperate with a file manager application to coordinate file recovery operations across different networks, network devices, and file duplication techniques. The flexible and robust nature of the recovery manager application increases a probability of success in file recovery, reduces latency associated with file recovery operations, and enhances user experience. Furthermore, the recovery manager application automates a number of file recovery tasks typically performed manually by a human operator, such as a network administrator, thereby increasing convenience and reducing costs associated with file recovery operations. As a result, the embodiments can improve affordability, scalability, modularity, extendibility, or interoperability for an operator, device or network.

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

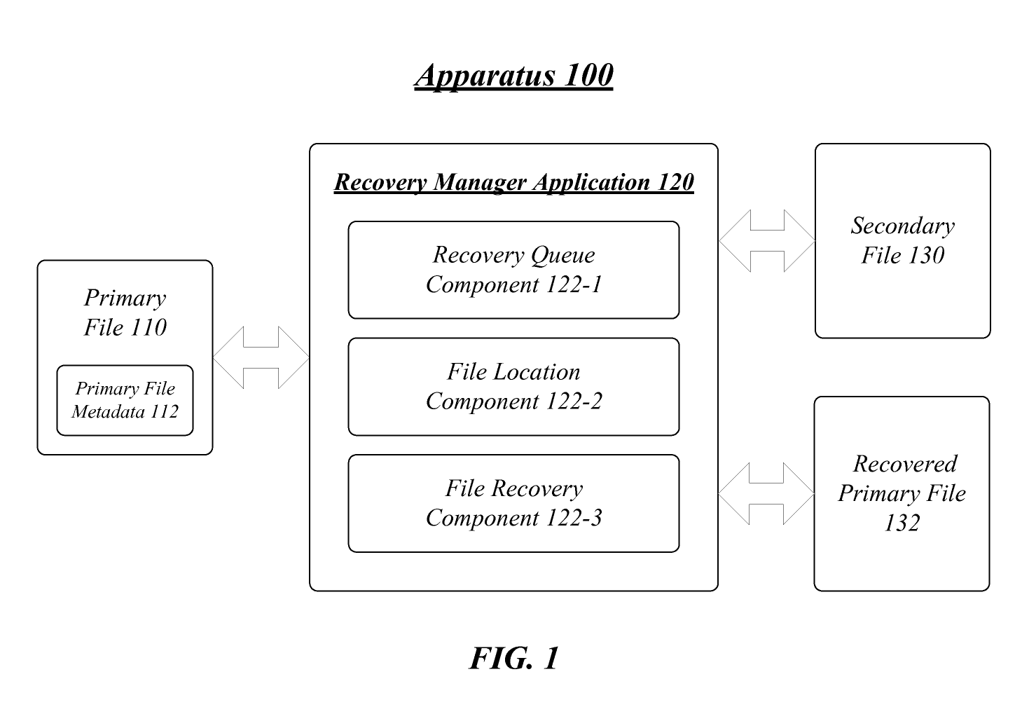

FIG. 1 illustrates a block diagram for an apparatus 100. In one embodiment, the apparatus 100 may comprise a computer-implemented apparatus 100 having a software application 120 comprising one or more components 122-a. Although the apparatus 100 shown in FIG. 1 has a limited number of elements in a certain topology, it may be appreciated that the apparatus 100 may include more or less elements in alternate topologies as desired for a given implementation.

It is worthy to note that “a” and “b” and “c” and similar designators as used herein are intended to be variables representing any positive integer. Thus, for example, if an implementation sets a value for a=5, then a complete set of components 122-a may include components 122-1, 122-2, 122-3, 122-4 and 122-5. The embodiments are not limited in this context.

The apparatus 100 may comprise a recovery manager application 120. The recovery manager application 120 may be implemented using any number of programming languages or software frameworks. In one embodiment, the recovery manager application 120 may comprise a software application written in a .NET Framework, which is a software framework developed by Microsoft® Corporation, Redmond, Wash. The .NET framework includes an application program interface (API) library and provides language interoperability across several programming languages (e.g., each language can use code written in other languages). Programs written for the .NET Framework execute in a software environment, known as the Common Language Runtime (CLR), an application virtual machine that provides services such as security, memory management, and exception handling. The class library and the CLR together constitute the .NET Framework. Although embodiments may be described with reference to the .NET Framework, it may be appreciated that other software frameworks may be used as well, such as Java. Java is a general-purpose, concurrent, class-based, object-oriented computer programming language that is specifically designed to have as few implementation dependencies as possible. It is intended to let application developers “write once, run anywhere” (WORA), meaning that code that runs on one platform does not need to be recompiled to run on another. Java applications are typically compiled to bytecode (class file) that can run on any Java virtual machine (JVM) regardless of computer architecture. Embodiments are not limited in this context.

The recovery manager application 120 may be generally arranged to manage file recovery operations for a storage network, such as a NAS or SAN. In one embodiment, the recovery manager application 120 may manage file recovery operations in response to a request from a third party entity, such as a file sharing application, for example. The recovery manager application 120 may receive a request to recover a primary file 110 deleted from a primary storage server. The recovery manager application 120 may locate a secondary file 130 for the primary file 110, and use the secondary file 130 to recover the primary file 110 to form a recovered primary file 132.

A primary file 110 may have one or more secondary files 130 stored in one or more secondary storage servers. Data integrity is paramount in a storage network. Loss of data may cause irreparable harm to the owner of the data. Therefore, whenever a storage network stores a primary file 110 in a primary storage server, various secondary files 130 of the primary file 110 are stored in secondary storage servers throughout a storage network. However, having multiple secondary files 130 from a primary file 110 may consume significant amounts of storage space, which becomes a problem when considering the massive volumes of data requiring storage. As such, there is often a trade-off made between data integrity and data storage space, with a balance made in view of a relative importance of a primary file 110.

Each secondary storage server may be configured to utilize a different file duplication technique. As different primary files 110 may have different levels of priority and importance, a different file duplication technique may be used for a given primary file 110 to reflect its priority and importance. As a result, a given primary file 110 may be duplicated using a different file duplication technique. In some cases, a primary file 110 may be duplicated using multiple file duplication techniques. For instance, a primary file 110 may be duplicated using a file duplication technique at a file level, while also duplicated using a file duplication technique at a file system level, a volume level, a device level, a system level, and so forth. As a result, a single primary file 110 may have more than one secondary file 130, and further, each of the secondary files 130 may be created using an entirely different type of file duplication technology. As a result, locating a secondary file 130 for a deleted primary file 110 may involve in-depth knowledge of each of the file duplication techniques used to create the secondary file 130 and/or the secondary storage server used to store the secondary file 130. Due to this complexity, many file recovery techniques are typically performed manually by a human operator, such as a system administrator for a storage network, in order to navigate the myriad different types of storage systems.

The recovery manager application 120 attempts to automate location and recovery of one or more secondary files 130 for a deleted primary file 110 across heterogeneous storage systems and file duplication technologies. The recovery manager application 120 may then use the secondary file 130 to create a recovered primary file 132 for the deleted primary file 110.

The recovery manager application 120 may comprise a recovery queue component 122-1. The recovery queue component 122-1 may be generally arranged to process file recovery requests. A file recovery request may comprise a request to recover a file deleted from a device or storage network. In one embodiment, the recovery queue component 122-1 may interoperate with a recovery queue, such as a recovery queue managed by the file manager application, for example. The recovery queue component 122-1 may monitor the recovery queue for file recovery work items, retrieve file recovery work items and associated information, and notify other components 122-a of incoming tasks, such as a file location component 122-2.

In one embodiment, the recovery queue component 122-1 may process a file recovery request to recover a primary file 110 deleted from a primary storage server. A given file in a storage network may have multiple copies, such as an original file and one or more copies of the original file. A given file in a storage network may also have multiple versions, such as an original file version and one or subsequent file versions. Typically each of the subsequent file versions contain some change to file content for a file, where a latest version in time represents a most current state of the file content. A primary file may refer to a first instance of a file, such as the original file or a latest version of the original file. A primary storage server may refer to a storage device storing the primary file.

A primary file 110 may have a set of primary file metadata 112. Primary file metadata 112 may comprise a set of information that describes a given primary file 110. Examples of primary file metadata 112 may include without limitation a filename, a file location, a file size, a file type, a file structure, file properties, file attributes, timestamps, version numbers, tags, and other descriptive information. Embodiments are not limited in this context.

The recovery manager application 120 may comprise a file location component 122-2. The file location component 122-2 may be generally arranged to search, identify or otherwise locate resources suitable for use in file recovery operations of a deleted primary file 110. Resources may include copies of the deleted file, alternate versions of the deleted file, previous versions of the deleted file, partial versions of the deleted file, blocks from the deleted file, and so forth.

In various embodiments, the file location component 122-2 may attempt to locate a secondary file 130 for the deleted primary file 110. As previously described, a given file in a storage network may have multiple copies, such as an original file and one or more copies of the original file. A given file in a storage network may also have multiple versions, such as an original file version and one or subsequent file versions.

In one embodiment, a secondary file 130 may comprise a copy of the primary file 110. For example, the file location component 122-2 may attempt to locate a complete copy of the primary file 110. In cases where a complete copy of the primary file 110 is not available, the file location component 122-2 may attempt to locate portions of the primary file 110, such as blocks or fragments of the primary file 110, which may be useful in reconstructing the primary file 110.

In one embodiment, a secondary file 130 may comprise a version of the primary file 110. For example, the file location component 122-2 may attempt to locate a latest version of the primary file 110. In cases where a latest version of the primary file 110 is not available, the file location component 122-2 may attempt to locate previous versions of the primary file 110, which may be useful in reconstructing the primary file 110.

The recovery manager application 120 may comprise a file recovery component 122-3. The file recovery component 122-3 may be generally arranged to perform file recovery operations for the deleted primary file 110. The file recovery component 122-3 may utilize the various resources located by the file location component 122-2, such as the secondary file 130, and attempt to recover, reconstruct or reproduce the deleted primary file 110 using the located resources. In the event the deleted primary file 110 is not completely recovered, the file recovery component 122-3 may catalog any recovery errors, which may be later surfaced to a user via a user interface (UI) during the file recovery reporting phase.

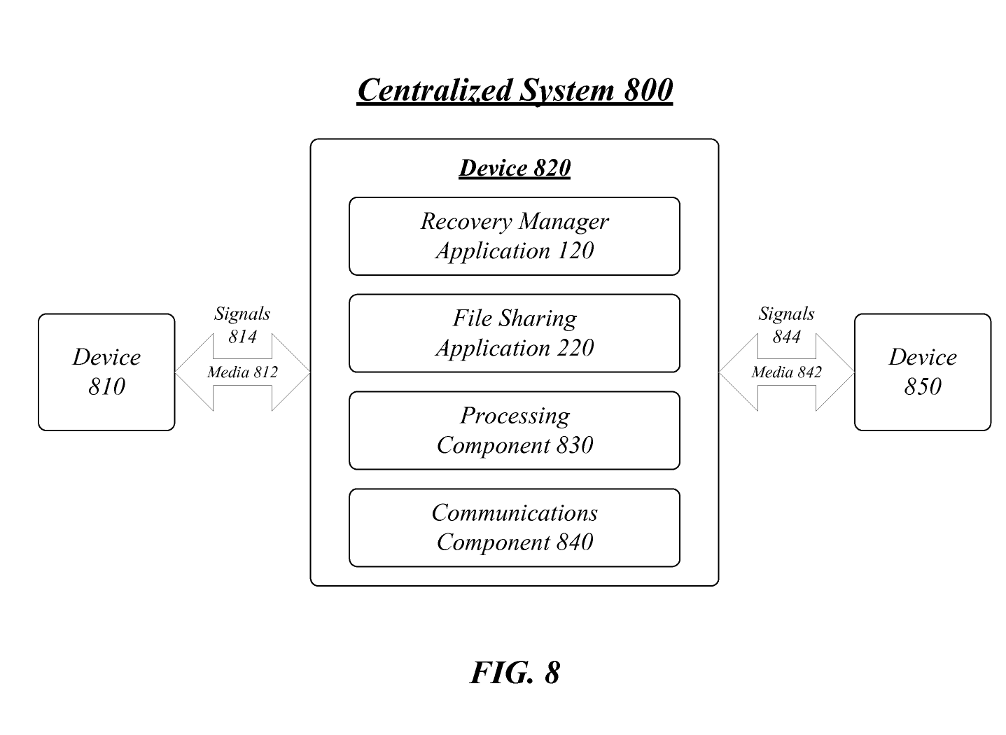

In general operation, the recovery manager application 120 may be implemented on an electronic device having processing capabilities, such as a processor circuit, for example. Examples of suitable electronic devices are provided with reference to FIGS. 8-10 and 15. Alternatively, some or all of the recovery manager application 120 may be implemented as dedicated circuitry, such as an application specific integrated circuit (ASIC), a field programmable gate array (FPGA), and so forth. Embodiments are not limited in this context.

The recovery manager application 120 may execute on a processor circuit to initiate file recovery operations on behalf of a file sharing application. The recovery queue component 122-1 may receive a request to recover a primary file 110 deleted from a primary storage server, and notify the file location component 122-2. The file location component 122-2 may locate a secondary file 132 stored in a secondary storage server in response to the request. The secondary file 132 may comprise, for example, a copy or version of the primary file 110. The secondary storage server may comprise, for example, one of multiple secondary storage servers. Each of the secondary storage servers may utilize a different file duplication technique. The file recovery component 122-3 may then retrieve the secondary file 132 from the secondary storage server, and create a recovered primary file 130 based at least in part on the secondary file 132.

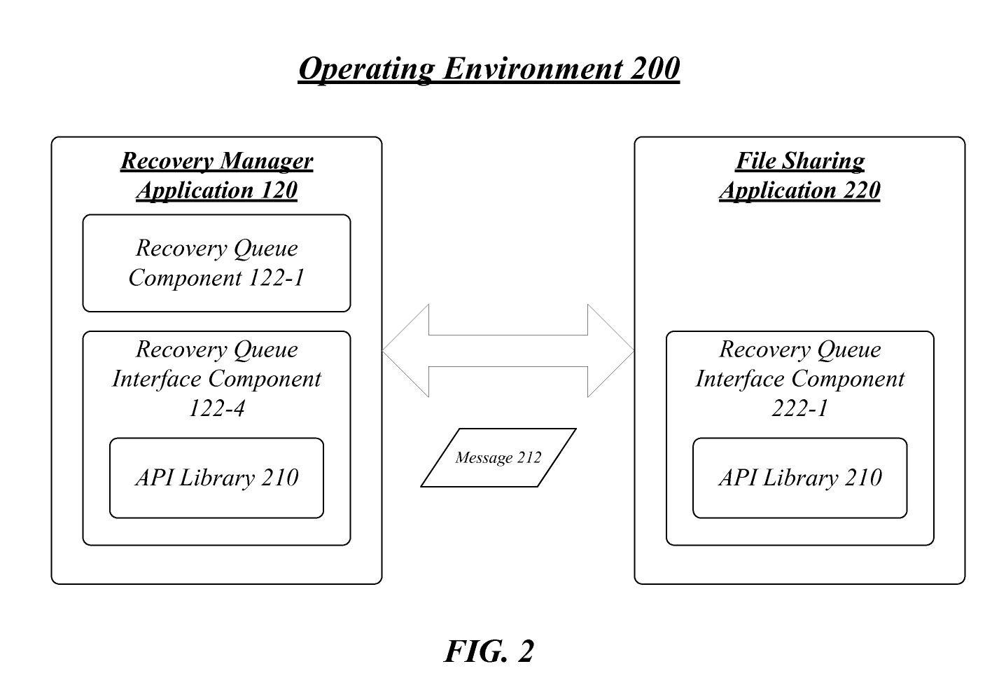

FIG. 2 illustrates an embodiment of an operational environment 200 for the apparatus 100. As shown in FIG. 2, the recovery manager application 120 may comprise the recovery queue interface component 122-1, which is designed to communicate with a file sharing application 220 using a programmatic interface for a request-response message system. An example of a request-response message system may include without limitation a representational state transfer (REST) message system. However, embodiments are not limited to this example.

The file sharing application 220 may be implemented using any number of programming languages or software frameworks. In various embodiments, the file sharing application 220 may be implemented using the same programming language or software framework used by the recovery manager application 120. In one embodiment, for example, the file sharing application 220 may be implemented as a software application written in a .NET Framework.

The file sharing application 220 may generally comprise an application that allows users to share and synchronize files across multiple heterogeneous devices. In one embodiment, the file sharing application 220 may be designed to securely service and store enterprise data for an entity, such as a commercial or non-commercial entity. The file sharing application 220 may be implemented in a private network, such as in a datacenter for a business entity as part of a business information technology (IT) network. The file sharing application 220 may also be implemented in a public network, such as in a cloud computing platform providing cloud-based file sharing and storage service built for a business entity and accessible via a network utilizing one or more Internet Engineering Task Force (IETF) protocols, such as the Internet.

As with the recovery manager application 120, the file sharing application 220 may be implemented as a software application comprising one or more components 222-b. As shown in FIG. 2, the file sharing application 220 may include a recovery queue interface component 222-1 having an application program interface (API) library 210. Although the file sharing application 220 shown in FIG. 2 has a limited number of elements in a certain topology, it may be appreciated that the file sharing application 220 may include more or less elements in alternate topologies as desired for a given implementation.

In one embodiment, the recovery manager application 120 and the file sharing application 220 may comprise separate and stand-alone classes of software programs, each offering a separate set of functions directed to data management. For instance, the recovery manager application 120 may be designed principally for a storage network that provides file-level of block-level data storage, such as a NAS or a SAN. An example of the recovery manager application 120 may include a NetApp® Recovery Manager, made by NetApp, Inc, Sunnyvale, Calif. The file sharing application 220 may be designed principally for a file sharing network that provides secure file sharing across multiple client devices. An example of the file sharing application 220 may include Citrix® ShareFile® made by Citrix Systems, Inc., Fort Lauderdale, Fla. Embodiments are not limited to these examples.

The recovery manager application 120 and the file sharing application 220 may be owned and operated by different business entities. For instance, the recovery manager application 120 may comprise a program designed, developed or maintained by a first business entity, such as a business entity providing storage network technology, such as NetApp, Inc. The file sharing application 220 may comprise a program designed, developed or maintained by a second business entity, such as a business entity providing file sharing technology, such as Citrix Systems, Inc. Embodiments are not limited to these examples.

As the recovery manager application 120 and the file sharing application 220 are separate stand-alone programs, a certain level of integration between the programs is necessary to coordinate operations. To provide interoperability, the recovery manager application 120 may include a recovery queue interface component 122-4 and the file sharing application 220 may include a recovery queue interface component 222-1. The recovery queue interface components 122-4, 222-1 may operate as an interface between the different programs. Each of the recovery queue interface components 122-4, 222-1 may have access to an API library 210. The recovery queue interface components 122-4, 222-1 may utilize various API of the API library 210 to communicate messages between each other to coordinate operations for the respective recovery manager application 120 and the file sharing application 220. In one embodiment, the API library 210 may comprise multiple web APIs, such as a low-level CloudStack™ API made by Citrix Systems, Inc., Amazon Web Services (AWS) API made by Amazon.com, Inc., and other APIs suitable for operating in a web based network environment.

In one embodiment, the recovery queue interface components 122-4, 222-1 may implement a request-response message system, such as REST message system, for example. The recovery manager application 120 and the file sharing application 220 may utilize the recovery queue interface components 122-4, 222-1 to pass messages 212 to each other to pass control information and data information. In one embodiment, messages 212 may comprise REST messages, although other suitable protocols may be used as well.

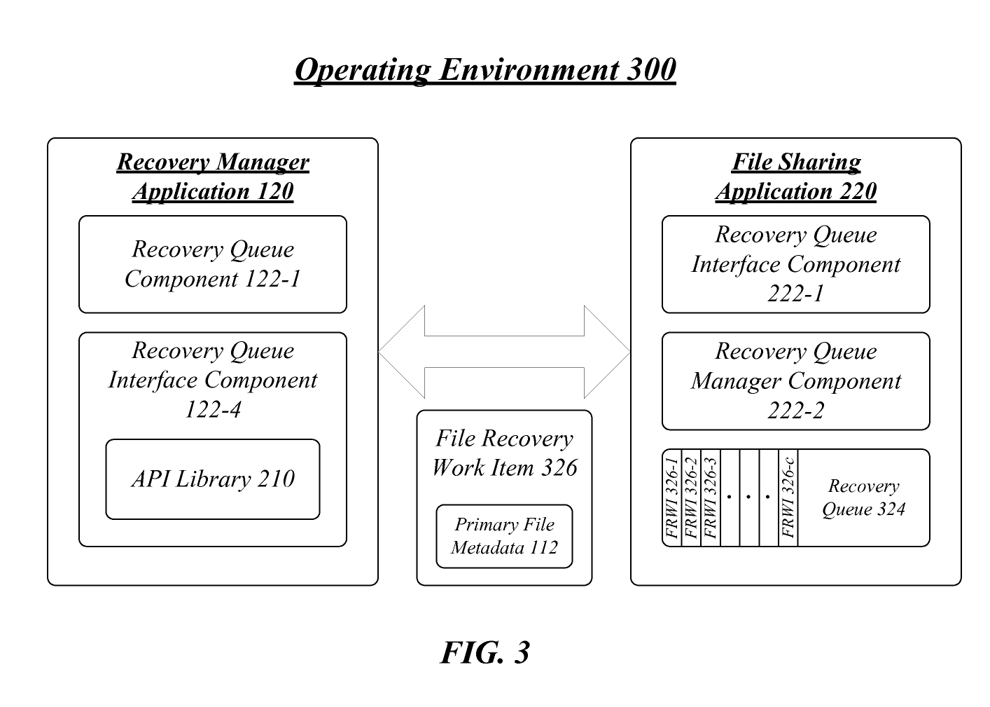

FIG. 3 illustrates an embodiment of an operational environment 300 for the apparatus 100. The operational environment 330 may demonstrate an example of interoperations between the recovery manager application 120 and the file sharing application 220.

As shown in FIG. 3, the file sharing application 220 may include a recovery queue manager component 222-2 and a recovery queue 324. The recovery queue 324 may store various file recovery work items 326-c. A file recovery work item (FCWI) 326-c may represent a request to recover a file deleted from a storage location, such as a primary file 110. For instance, a user of the file sharing application 220 may request a primary file 110 to be deleted from a storage device in a storage network. The user may desire to later undelete the file, and utilize a user interface (UI) of the file sharing application 220 to request file recovery operations for the deleted file. The file sharing application 220 may receive the user command, and issue a control directive to recover the deleted file. The control directive is converted to a FRWI 326-c, and place the FRWI 326-c in the recovery queue 324.

The recovery queue component 122-1 of the recovery manager application 120 may utilize the recovery queue interface component 122-4 to monitor the recovery queue 324 of the file sharing application 120. The monitoring may be performed on a periodic, aperiodic or continuous basis. Alternatively, the file sharing application 220 may utilize the recovery queue manager component 222-2 to notify the recovery queue component 122-1 when a new FRWI 326-c is stored in the recovery queue 324. In either case, at some point the recovery queue component 122-1 may detect when a FRWI 326-c is stored in the recovery queue 324.

In one embodiment, the FRWI 326-c may represent the request to recover a primary file 110 deleted from a primary storage server. When the recovery queue component 122-1 detects a FRWI 326-c stored in the recovery queue 324, the recovery queue component 122-1 may retrieve FRWI 326-c from the recovery queue 324 of the file sharing application 220 via the recovery queue interface components 122-4, 222-1. The recovery queue component 122-1 may also retrieve primary file metadata 112 for the deleted primary file, the primary file metadata 112 to include a filename for the deleted primary file, among other metadata. The primary file metadata 112 may be used to assist in locating and/or recovering the deleted primary file.

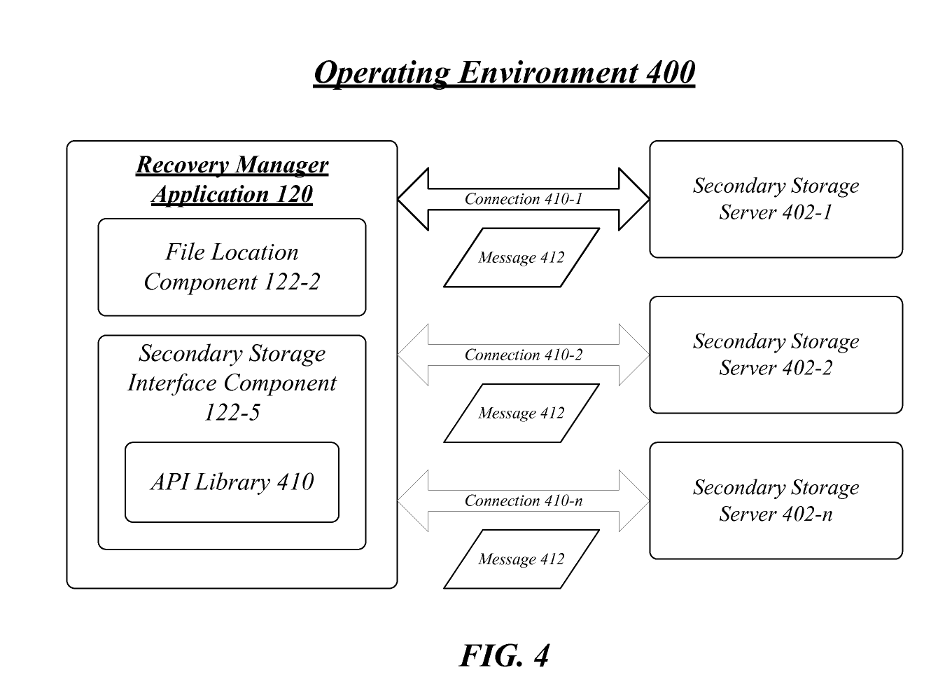

FIG. 4 illustrates an embodiment of an operational environment 400 for the apparatus 100. The operational environment 400 illustrates an example of file location operations performed by the file location component 122-2 of the recovery manager application 120.

Once the recovery queue component 122-1 retrieves a new FRWI 326-c, the recovery queue component 122-1 may pass the FRWI 326-c and primary file metadata 112 of the deleted primary file 110 to the file location component 122-2. The file location component 122-2 may initiate file location operations in an attempt to locate a secondary file 130 for the deleted primary file 110. The file location component 122-2 may search for a secondary file 130 as stored in one or more secondary storage servers 402-n in response to the FRWI 326-c. The secondary file 132 may comprise, for example, a copy or version of the primary file 110.

A primary file 110 may have one or more secondary files 130 stored in one or more secondary storage servers 402-n. Each secondary storage server 402-n may be configured to utilize a different file duplication technique. As a result, locating a secondary file 130 for a deleted primary file 110 may involve in-depth knowledge of each of the file duplication techniques used to create the secondary file 130 and/or the secondary storage server 402-n used to store the secondary file 130. The file location component 122-2 of the recovery manager application 120 automates location and recovery of one or more secondary files 130 for a deleted primary file 110 across heterogeneous storage systems and file duplication technologies.

In one embodiment, a secondary storage server 402-1 may utilize a first file duplication technique that creates read-only, static, immutable copies of a secondary file 130 for a primary file 110 at different points of time. An example of a first file duplication technique may include a snapshot technique, such as the NetApp Snapshot™ solution. A snapshot copy is a point-in-time file system image. Low-overhead snapshot copies are made possible by utilizing a Write Anywhere File Layout (WAFL®) storage virtualization technology that is part of the NetApp Data ONTAP® operating system. Like a database, WAFL uses pointers to the actual data blocks on disk, but, unlike a database, WAFL does not rewrite existing blocks; it writes updated data to a new block and changes the pointer. A snapshot copy simply manipulates block pointers, creating a “frozen” read-only view of a WAFL volume that lets applications access older versions of files, directory hierarchies, and/or logical unit numbers (LUNs) without special programming. Because actual data blocks are not copied, snapshot copies are extremely efficient both in the time needed to create them and in storage space. A snapshot copy takes only a few seconds to create, typically less than one second, regardless of the size of the volume or the level of activity on the storage system. After a snapshot copy has been created, changes to data objects are reflected in updates to the current version of the objects, as if snapshot copies did not exist. Meanwhile, the snapshot copy of the data remains completely stable. A snapshot copy incurs no performance overhead; users can store up to 255 snapshot copies per WAFL volume, all of which are accessible as read-only and online versions of the data.

In one embodiment, a secondary storage server 402-2 may utilize a second file duplication technique that creates a secondary file 130 for a primary file 110 using an entire system backup. An example of a second file duplication technique may include a backup of an entire primary site with a secondary site to provide high-availability (e.g., “five nines” availability) suitable for disaster recovery, such as a NetApp SnapMirror® solution. With NetApp SnapMirror, the core technologies in Data ONTAP®, including Snapshot™ and deduplication, combine to reduce the amount of data that is actually transmitted over the network by sending only changed blocks. In addition, SnapMirror reduces bandwidth needs and associated costs by implementing network compression, which accelerates data transfers and reduces the network bandwidth utilization. To further reduce network bandwidth requirements, SnapMirror automatically takes checkpoints during data transfers. If a storage system goes down, the transfer restarts from the most recent checkpoint. To eliminate the need for full transfers when recovering from a broken mirror or loss of synchronization, SnapMirror also performs intelligent resynchronization. If data on the mirrored copy was modified during application testing, it can be quickly resynchronized with the production data by copying the new and changed data blocks from the production system to the mirrored copy.

In one embodiment, a secondary storage server 402-3 may utilize a third file duplication technique that creates a secondary file 130 for a primary file 110 at different points of time using a replication-based disk-to-disk backup. An example of a third file duplication technique may include a disk-to-disk technique, such as the NetApp SnapVault® solution. SnapVault creates a full point-in-time backup copy on disk, then transfers and stores only new or changed blocks. This minimizes data transfer over the wire. It also reduces the backup footprint, similar to dedicated deduplication appliances. Each “block incremental” backup is a full backup copy. However, only the new or changed blocks are added to the footprint. SnapVault builds upon snapshot copies by turning them into long-term backup copies. SnapVault can leverage fabric-attached storage (FAS) deduplication to shrink a backup footprint. For instance, SnapVault can backup a primary FAS system to a secondary FAS system.

It may be appreciated that the above described file duplication techniques are provided by way of example and not limitation. The exemplary file duplication techniques merely represent a level of diversity found in file duplication technologies, and an associated level of complexity involved in locating a recovering a given secondary file 130 for a given primary file 110. The recovery manager application 120 may be implemented for other file duplication techniques as well.

As shown in FIG. 4, the file location component 122-2 may search each of the multiple secondary storage servers 402-n for a secondary file 130. The file location component 122-2 may utilize a secondary storage interface component 122-5 to interface with each of the multiple secondary storage servers 402-n. The secondary storage interface component 122-5 may include an API library 410 having a set of APIs suitable for communicating with each of the secondary storage servers 402-n. In one embodiment, for example, the API library 410 may comprise a Data ONTAP® PowerShell Toolkit (PSTK) for a Microsoft® Windows® PowerShell. PowerShell is a task automation framework comprising a command-line interface (CLI) shell and an associated scripting language built on top of, and integrated with, the Microsoft.NET Framework. PowerShell enables administrators to perform administrative tasks on both local and remote Windows systems. Embodiments are not limited to this example.

The file location component 122-2 may initiate a connection 410-n with each of the multiple secondary storage servers 402-n utilizing the API library 410 of the secondary storage interface component 122-5. The file location component 122-2 may communicate with the secondary storage servers 402-n by sending and receiving messages 412 over the appropriate connections 410-n. The message 412 may comprise, for example, Zephyr API (ZAPI) messages, REST messages, or messages from some other suitable protocol.

The file location component 122-2 may search each of the multiple secondary storage servers 402-n for a secondary file 130 based on a type of file duplication technique used to store the secondary file 130. For instance, to search the secondary storage server 402-1, the file location component 122-2 may utilize a search technique customized for the first file duplication technique. To search the secondary storage server 402-2, the file location component 122-2 may utilize a search technique customized for the second file duplication technique. To search the secondary storage server 402-3, the file location component 122-2 may utilize a search technique customized for the third file duplication technique, and so forth.

Each of the file duplication techniques may necessitate different search tools and parameters to locate a secondary file 130. For instance, there may arise semantic differences between accessing a file on the secondary storage server 402-1 and the secondary storage server 402-2. Some file duplication techniques may use case-sensitive filenames, while others may use case-insensitive filenames. Some file duplication techniques may utilize human readable filenames, such as words in a human language, while others may use machine-readable filenames comprising a lengthy sequence of random numbers, letters and symbols. File duplication techniques may differ in file formats, length of filenames, file locations, file structures, file hierarchies, file storage techniques, file retrieval techniques, file identification techniques, file references, file versions, file version identification, file security type, file protocols, file semantics, permission structures, and a myriad number of other factors. File duplication techniques may also vary according to different software frameworks and programming languages used for secondary storage servers 402-n. File duplication techniques may further vary according to physical or logical characteristics of client devices, storage devices, storage appliances, storage networks, and other characteristics. File duplication techniques may further vary according to physical or logical characteristics of networks, network connections, communications protocols, communication interfaces, media access technologies, transceivers, and other network characteristics. Embodiments are not limited to these examples.

As a result of these and other differences between file duplication techniques, the file location component 122-2 may utilize custom algorithms to search for a secondary file 130 in each of the heterogeneous secondary storage servers 402-n. This reduces or eliminates the need for a system administrator to intervene during file recovery operations.

The file location component 122-2 may search each of the multiple secondary storage servers 402-n for a secondary file 130 using a number of different search patterns. In one embodiment, the file location component 122-2 may search each of the multiple secondary storage servers 402-n for a secondary file 130 in sequence to increase a probable hit at the expense of file retrieval times. A particular order for the sequence may be based on any number of factors, such as type of primary file 110, a source of a primary file 110, a primary storage server for a primary file 110, a user of a primary file 110, a type of secondary file 130, a type of storage network, historical information (e.g., previous searches), profiles, system parameters, and so forth. In one embodiment, the file location component 122-2 may search each of the multiple secondary storage servers 402-n for a secondary file 130 in parallel to accelerate retrieval time at the expense of bandwidth. In one embodiment, the file location component 122-2 may search each of the multiple secondary storage servers 402-n for a secondary file 130 in a random pattern. Embodiments are not limited in this context.

In one embodiment, the file location component 122-2 may search each of the multiple secondary storage servers 402-n for a secondary file 130, and terminate search operations once a single instance of a secondary file 130 is located. In this case, the file location component 122-2 may select the solitary located secondary file 130 for use in generating the recovered primary file 132. In another embodiment, the file location component 122-2 may search all of the multiple secondary storage servers 402-n for as many instances of the secondary file 130 as can be located, and terminate search operations once all of the multiple secondary storage servers 402-n are searched. In this case, the file location embodiment 122-2 may order all found instances of the secondary file 130 according to a defined set of ranking criteria, and select one of a single instance of the secondary file 130 for use in generating the recovered primary file 132. Examples of ranking criteria may include without limitation a source of a secondary file 130, a location of a secondary file 130, a state of a secondary file 130, a version of a secondary file 130, a secondary storage server 402-n storing a secondary file 130, a file size for a secondary file 130, metadata for a secondary file 130, properties for a secondary file 130, attributes of a secondary file 130, connection speeds for connections 410-n, traffic of connections 410-n, user programmed criteria, properties or attributes of a primary file 110 or primary storage server 402, and so forth. These are merely a few examples of ranking criteria, and others may be used as well for a given implementation. The embodiments are not limited in this context.

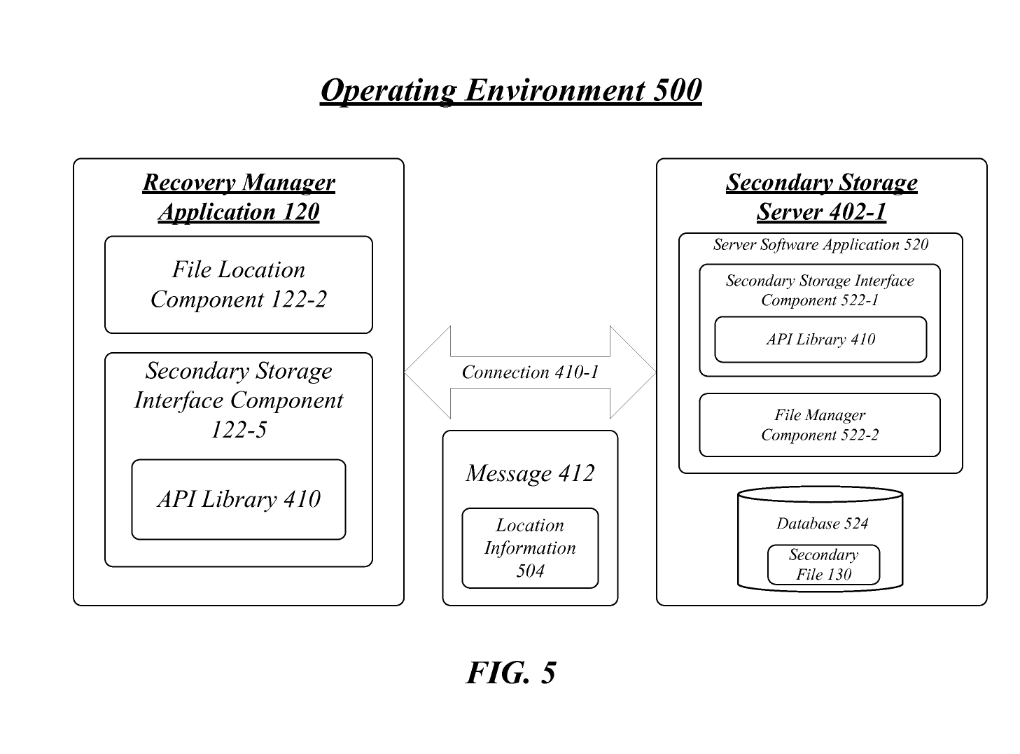

FIG. 5 illustrates an embodiment of an operational environment 500 for the apparatus 100. The operational environment 500 illustrates a representative example of the file location component 122-2 searching the secondary storage server 402-1 for a secondary file 130.

As with the recovery manager application 120 and the file sharing application 220, a given secondary storage server 402-n may be implemented with a server software application 520 comprising one or more components 522-d. As shown in FIG. 5, the server software application 520 may include a secondary storage interface component 522-1 having an API library 410 matching or complementing the API library 410 of the secondary storage interface component 122-5 of the recovery manager application 120. Although the server software application 520 shown in FIG. 5 has a limited number of elements in a certain topology, it may be appreciated that the server software application 520 may include more or less elements in alternate topologies as desired for a given implementation.

The server software application 520 may be implemented using any number of programming languages or software frameworks. In various embodiments, the server software application 520 may be implemented using the same programming language or software framework used by the recovery manager application 120 and/or the file sharing application 220. In one embodiment, for example, the server software application 520 may be implemented as a software application written in a programming language such as C/C++ and designed for execution on a NetApp storage server running the Data ONTAP operating system. Embodiments are not limited to this example.

As shown in FIG. 5, the file location component 122-2 may search a secondary storage server 402-1 for a secondary file 130 based a type of file duplication technique used to store the secondary file 130. The file location component 122-2 may establish a connection 410-1 with the secondary storage server 402-1, and search a database 524 for the secondary file 130. Alternatively, the file location component 122-2 may provide a control directive to the file manager component 522-2 to search the database 524 for the secondary file 130. If the secondary file 130 is found in the database 524, the file location component 122-2 may retrieve location information 504 for the secondary file 130 via one or more messages 412. The location information 504 may identify the secondary storage server 402-1 and a location of the secondary file 130 within the database 524. Additionally or alternatively, the file location component 122-2 may retrieve the actual secondary file 130. If the secondary file 130 is not found in the database 524, the file location component 122-2 may continue searching for the secondary file 130 in another secondary storage server 402-n. The file location component 122-2 may pass the location information 504 and/or the secondary file 130 to the file recovery component 122-3.

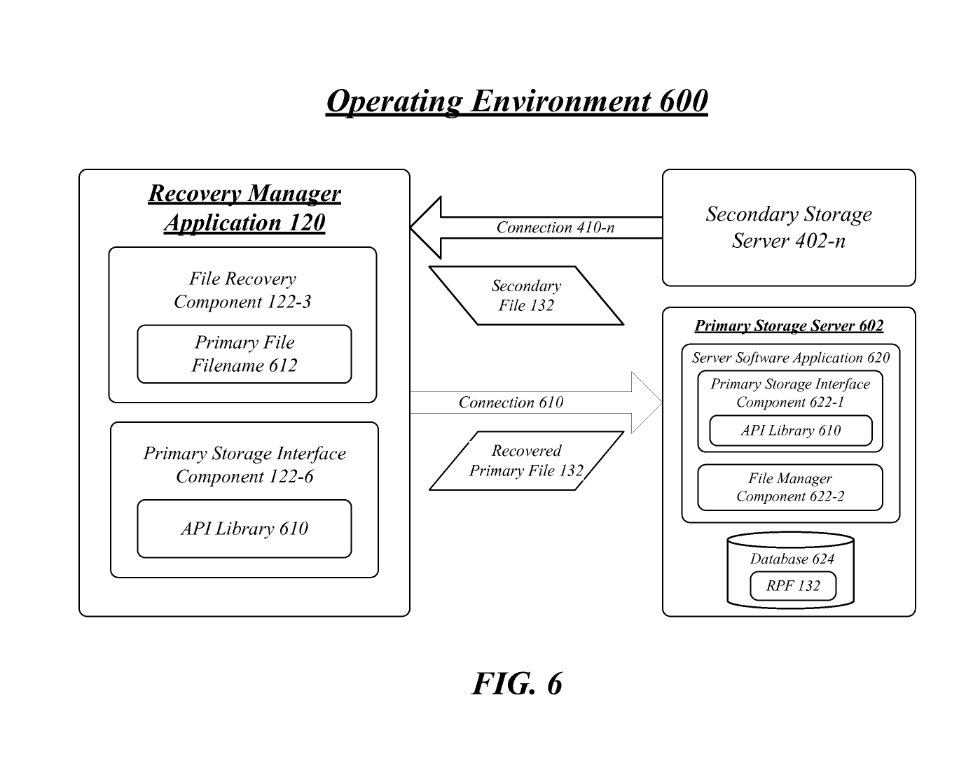

FIG. 6 illustrates an embodiment of an operational environment 600 for the apparatus 100. The operational environment 600 illustrates a case where the file recovery component 122-3 may generate a recovered primary file 132 for a primary file 110 from a secondary file 130.

In various embodiments, a recovered primary file 132 may be stored in a primary storage server 602. The primary storage server 602 may comprise a server primarily used to store files for a given user, device or system. In one embodiment, for example, the primary storage server 602 may comprise a server from which the primary file 130 was originally deleted, although this is not necessarily true for all cases.

As with the recovery manager application 120 and the file sharing application 220, a primary storage server 602 may be implemented with a server software application 620 comprising one or more components 622-e. As shown in FIG. 6, the server software application 620 may include a primary storage interface component 622-1 having an API library 610 matching or complementing an API library 610 of a primary storage interface component 122-6 of the recovery manager application 120. In some cases, the API library 610 may match the API library 410 of the secondary storage interface component 122-5 of the recovery manager application 120. Although the server software application 620 shown in FIG. 6 has a limited number of elements in a certain topology, it may be appreciated that the server software application 620 may include more or less elements in alternate topologies as desired for a given implementation.

The server software application 620 may be implemented using any number of programming languages or software frameworks. In various embodiments, the server software application 620 may be implemented using the same programming language or software framework used by the recovery manager application 120 and/or the file sharing application 220 and/or the server software application 520. In one embodiment, for example, the server software application 620 may be implemented as a software application written in a programming language such as C/C++ and designed for execution on a NetApp storage server running the Data ONTAP operating system. Embodiments are not limited to this example.

In those cases where the file location component 122-2 does not retrieve a secondary file 130, the file recovery component 122-3 may retrieve the secondary file 130 from a secondary storage server 402-n over a connection 410-n established utilizing the primary storage interface components 122-6, 622-1 and associated API library 610. The file recovery component 122-3 may then initiate operations to recover the deleted primary file 110 utilizing the secondary file 130 and the primary file metadata 112. In one embodiment, for example, the file recovery component 122-3 may create a recovered primary file 132 from the secondary file 130 by renaming the secondary file 130 to a filename 612 specified by the primary file metadata 112 associated with the file recovery work item 326-b. In other cases, more complex recovery operations may be needed based on a state of the secondary file 130 and associated file content. The file recovery component 122-3 may send the recovered primary file 132 to a primary storage server 602.

The file manager component 622-2 of the primary storage server 602 may store the recovered primary file 132 in the database 624. A user may utilize a client device to access the recovered primary file 132 from the database 624.

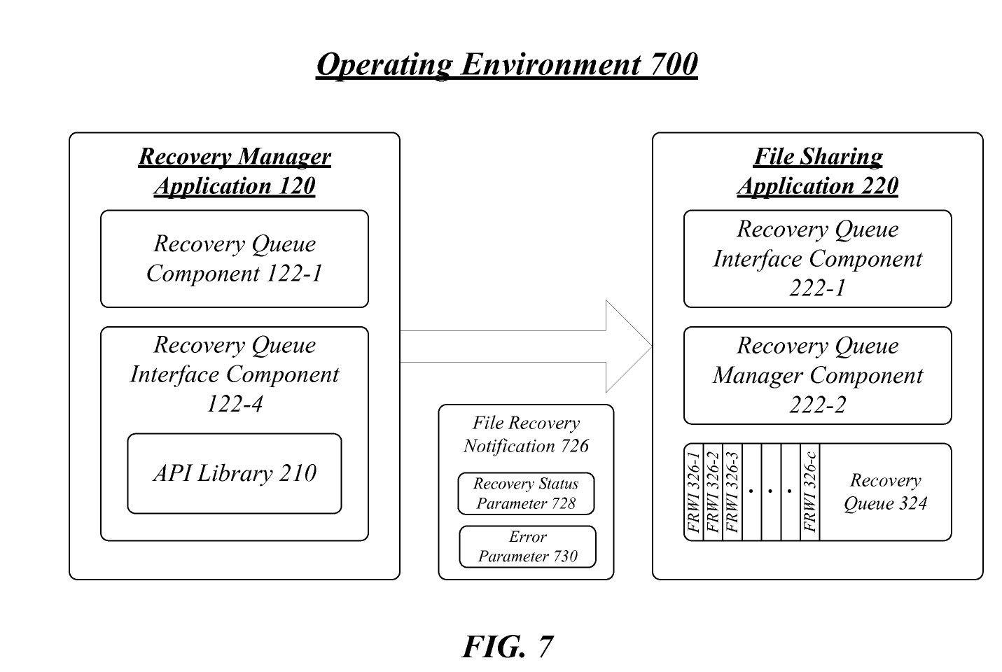

FIG. 7 illustrates an embodiment of an operational environment 700 for the apparatus 100. The operational environment 700 illustrates a case where the recovery queue component 122-1 of the recovery manager application 120 updates a status for a file recovery work item 326-c.

Once the file recovery component 122-3 generates a recovered primary file 132 and stores it in the primary storage server 604, the file recovery component 122-3 notifies the recovery queue component 122-1. The recovery queue component 122-1 may send a file recovery notification 726 to update a FRWI 326-c that initiated file recovery operations for the deleted primary file 110 in the recovery queue 324.

The file recovery notification 726 may include a recovery status parameter 728. A recovery status parameter 728 may indicate a recovery state for a deleted primary file 110. For instance, the recovery queue component 122-1 may set the recovery status parameter 728 to indicate successful creation of a recovered primary file 132 for a deleted primary file 110. The recovery queue component 122-1 may also set the recovery status parameter 728 to indicate unsuccessful creation (e.g., failure) of a recovered primary file 132 for a deleted primary file 110. The recovery queue component 122-1 may also set the recovery status parameter 728 to indicate other recovery states, such as partial success. In this manner, the file sharing application 220 may be notified of a current status for each FRWI 326-c.

When the recovery status parameter 728 indicates a partial success, the file recovery notification 726 may include an error parameter 730. An error parameter 730 may indicate one or more file errors in a recovered primary file 132 for a deleted primary file 130. Examples of file errors may include incomplete files, corrupted blocks, missing blocks, versions other than a latest version, and other file errors. The file sharing application 220 and/or a user may review the file errors indicated by the error parameter 730 and determine whether the recovered primary file 132 is suitable for an intended purpose of the file sharing application 220 and/or the user. In the event the recovered primary file 132 has too many errors tolerable by the file sharing application 220 and/or the user, the file sharing application 220 may generate a new FRWI 326-c (or update the previous FRWI 326-c) for the same deleted primary file 110 to restart file recovery operations by the recovery manager application 120. The recovery manager application 120 may then reinitiate file recovery operations for the same deleted primary file 110, using the error parameter as a feedback mechanism to refine location and recovery operations to improve chances of generating a recovered primary file 132 with a fewer number of errors, or a complete recovered primary file 132 with no errors.

FIG. 8 illustrates a block diagram of a centralized system 800. The centralized system 800 may implement some or all of the structure and/or operations for the apparatus 100 in a single computing entity, such as entirely within a single device 820.

The device 820 may comprise any electronic device capable of receiving, processing, and sending information for the apparatus 100. Examples of an electronic device may include without limitation an ultra-mobile device, a mobile device, a personal digital assistant (PDA), a mobile computing device, a smart phone, a telephone, a digital telephone, a cellular telephone, ebook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The device 820 may execute processing operations or logic for the apparatus 100 using a processing component 830. The processing component 830 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 820 may execute communications operations or logic for the apparatus 100 using communications component 840. The communications component 840 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 840 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 812, 842 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 820 may communicate with other devices 810, 850 over a communications media 812, 842, respectively, using communications signals 814, 844, respectively, via the communications component 840. The devices 810, 850 may be internal or external to the device 820 as desired for a given implementation.

As shown in FIG. 8, the recovery manager application 120 and the file sharing application 220 may execute on a same computing device 820. This implementation may be suitable, for example, when the recovery manager application 120 and the file sharing application 220 utilize a same software framework, such as the .NET Framework. This implementation may also be suitable, for example, when the recovery manager application 120 and the file sharing application 220 are implemented within a same storage center, such as a customer data center. Implementing the recovery manager application 120 and the file sharing application 220 in a same computing device 820 may increase efficiency in terms of increasing security, decreasing communications latency, and tighter integration. In this implementation, the device 810 may represent the primary storage server 602, and the device 850 may represent a secondary storage server 402-n.

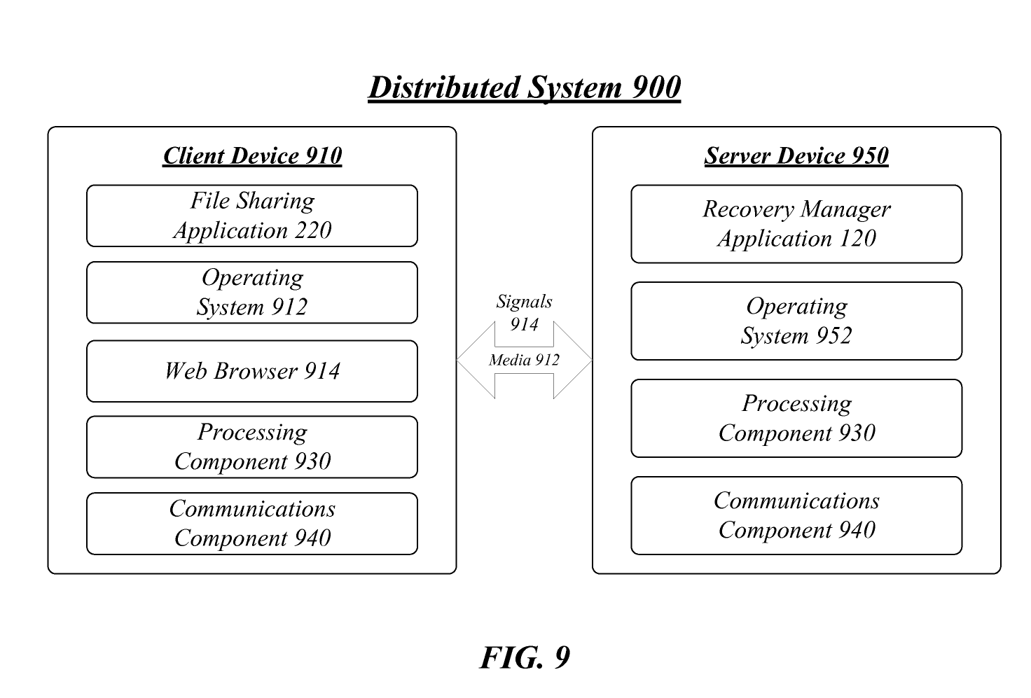

FIG. 9 illustrates a block diagram of a distributed system 900. The distributed system 900 may distribute portions of the structure and/or operations for the apparatus 100 across multiple computing entities. Examples of distributed system 900 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 900 may comprise a client device 910 and a server device 950. In general, the client device 910 and the server device 950 may be the same or similar to the client device 820 as described with reference to FIG. 8. For instance, the client system 910 and the server system 950 may each comprise a processing component 930 and a communications component 940 which are the same or similar to the processing component 830 and the communications component 840, respectively, as described with reference to FIG. 8. In another example, the devices 910, 950 may communicate over a communications media 912 using communications signals 914 via the communications components 940.

The client device 910 may comprise or employ one or more client programs that operate to perform various methodologies in accordance with the described embodiments. In one embodiment, for example, the client device 910 may implement the file sharing application 220. The file sharing application 220 may be considered a client program in that it requests services from the recovery manager application 120.

The server device 950 may comprise or employ one or more server programs that operate to perform various methodologies in accordance with the described embodiments. In one embodiment, for example, the server device 950 may implement the recovery manager application 120. The recovery manager application 120 may be considered a server program in that is services requests from the file sharing application 220.

As shown in FIG. 9, the file sharing application 220 and the recovery manager application 120 may execute on different computing devices, such as devices 910, 950, respectively. This implementation may be desirable when the file sharing application 220 and the recovery manager application 120 are not co-located in a same data center, or when written in different programming languages and/or software frameworks, thereby necessitating different software execution environments. Depending on a given implementation, the file sharing application 220 and the recovery manager application 120 may execute on operating systems 912, 952, respectively. The operating systems 912, 952 may be same or different operating systems, as desired for a given implementation. Embodiments are not limited in this context.

Client device 910 may further comprise a web browser 914. The web browser 914 may comprise any commercial web browser. The web browser 914 may be a conventional hypertext viewing application such as MICROSOFT INTERNET EXPLORER®, APPLE® SAFARI®, FIREFOX® MOZILLA®, GOOGLE® CHROME®, OPERA®, and other commercially available web browsers. Secure web browsing may be supplied with 128-bit (or greater) encryption by way of hypertext transfer protocol secure (HTTPS), secure sockets layer (SSL), transport security layer (TSL), and other security techniques. Web browser 914 may allow for the execution of program components through facilities such as ActiveX, AJAX, (D)HTML, FLASH, Java, JavaScript, web browser plug-in APIs (e.g., FireFox, Safari Plug-in, and the like APIs), and the like. The web browser 914 may communicate to and with other components in a component collection, including itself, and facilities of the like. Most frequently, the web browser 914 communicates with information servers (e.g., server devices 820, 850), operating systems, integrated program components (e.g., plug-ins), and the like. For example, the web browser 914 may contain, communicate, generate, obtain, and provide program component, system, user, and data communications, requests, and responses. Of course, in place of the web browser 914 and information server, a combined application may be developed to perform similar functions of both.

A human operator such as a network administrator may utilize the web browser 914 to access applications and services provided by the server device 950. For instance, the web browser 914 may be used to configure file recovery operations performed by the recovery manager application 120 on the server device 950. The web browser 914 may also be used to access cloud-based applications and services, such as online storage applications, services and tools.

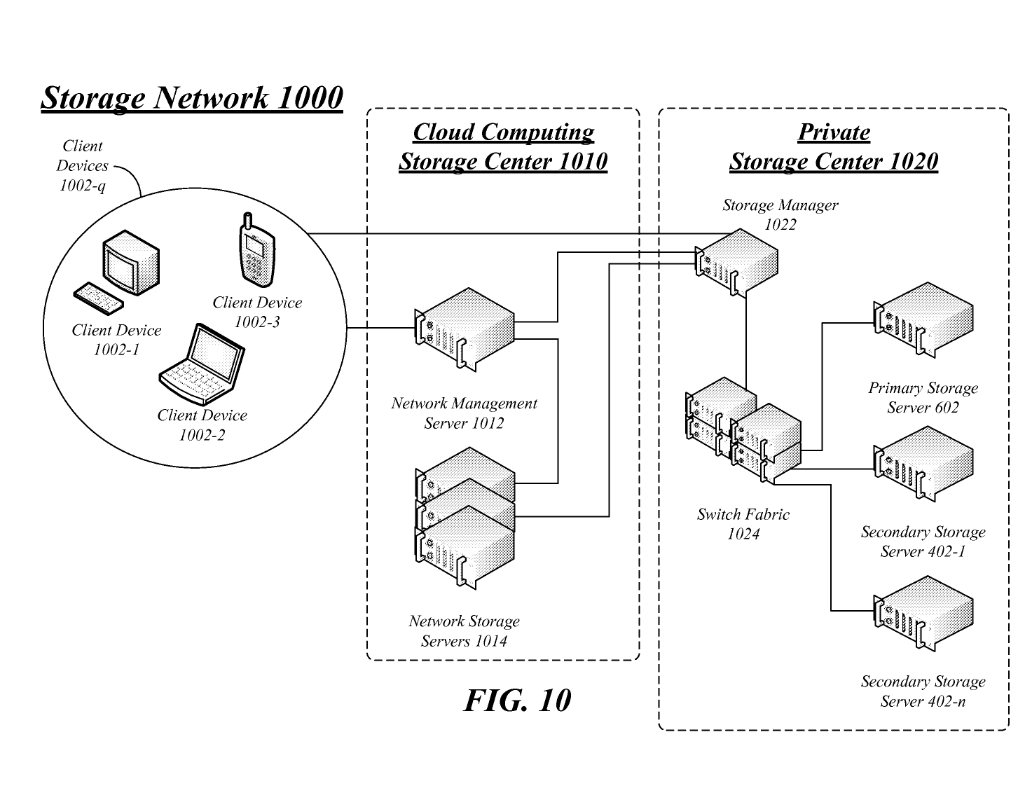

FIG. 10 illustrates an embodiment of a storage network 1000. The storage network 1200 provides a network level example of an environment suitable for use with the apparatus 100.

In the illustrated embodiment shown in FIG. 10, a set of client devices 1002-q may comprise client devices 1002-1, 1002-2 and 1002-3. The client devices 1002-q may comprise representative examples of a class of devices a user may utilize to access online storage services. As shown in FIG. 10, each client device 1002-q may represent a different electronic device a user can utilize to access a web services and web applications provided by a network management server 1012. For instance, the client device 1002-1 may comprise a desktop computer, the client device 1002-2 may comprise a notebook computer, and the client device 1002-3 may comprise a smart phone. It may be appreciated that these are merely a few examples of client devices 1002-q, and any of the electronic devices as described with reference to FIG. 8 may be implemented as a client device 1002-q (e.g., a tablet computer). The embodiments are not limited in this context.

A user may utilize a client device 1002-q to access various web services and web applications provided by a cloud computing storage center 1010 and/or a private storage center 1020. A cloud computing storage center 1010 and a private storage center 1020 may be similar in terms of hardware, software and network services. Differences between the two may include geography and business entity type. A cloud computing storage center 1010 is physically located on premises of a specific business entity (e.g., a vendor) that produces online storage services meant for consumption by another business entity (e.g., a customer). A private storage center 1020 is physically located on premises of a specific business entity that both produces and consumes online storage services. A private storage center 1020 implementation may be desirable, for example, when a business entity desires to control physical security to equipment used to implement the private storage center 1020.

A cloud computing storage center 1010 may utilize various cloud computing techniques to store data for a user of a client device 1002-q. Cloud computing is the use of computing resources (hardware and software) which are available in a remote location and accessible over a network (e.g., the Internet). A user may access cloud-based applications through a web browser or a light-weight desktop or mobile application while business software and user data are stored on servers at a remote location. An example of a cloud computing storage center 1010 may include a Citrix CloudPlatform® made by Citrix Systems, Inc.

As shown in FIG. 10, the cloud computing storage center 1010 may comprise a network management server 1012 and one or more network storage servers 1012. The network management server 1012 may be a representative example of a cloud-based storage file manager to manage files stored in one or more network storage servers 1014. The network management server 1012 and the network storage servers 1014 may be implemented as web servers using various web technologies. The network management server 1012 and the network storage servers 1014 may each comprise a stand-alone server or an array of servers in a modular server architecture or server farm.

A private storage center 1020 may be similar to the cloud computing storage center 1010 in terms of hardware, software and network services. The private storage center 1020 may comprise a storage manager 1022, a switch fabric 1024, a primary storage server 602, and one or more secondary storage servers 402-n. The storage manager 1022, primary storage server 602, and the one or more secondary storage servers 402-n may each comprise a stand-alone server or an array of servers in a modular server architecture or server farm.

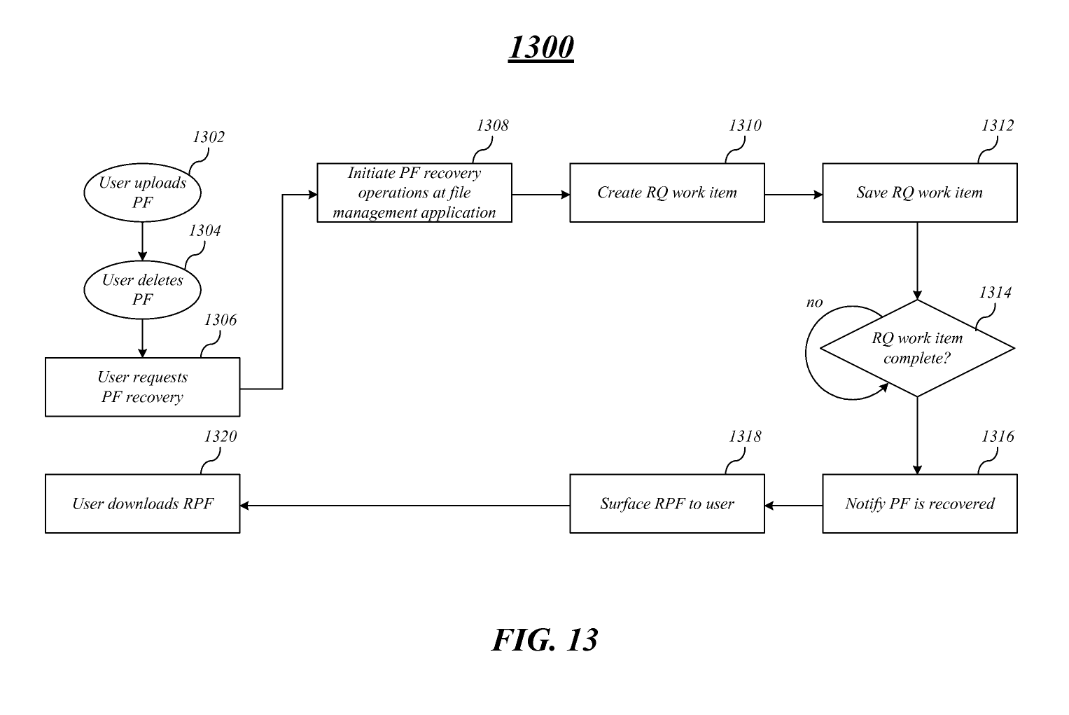

In general, a user may utilize one or more client devices 1002-q to access online file services provided by the cloud computing center 1010 and/or the private storage center 1020. For instance, a user may utilize a client device 1002-q to delete a primary file 110, and request file recovery operations for the deleted primary file 110. The cloud computing storage center 1010 and/or the private storage center 1020 may operate separately or together to implement file recovery operations to generate a recovered primary file 132 as previously described. Exemplary operations for the storage network 1000 may be explained in more detail with reference to FIG. 13.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

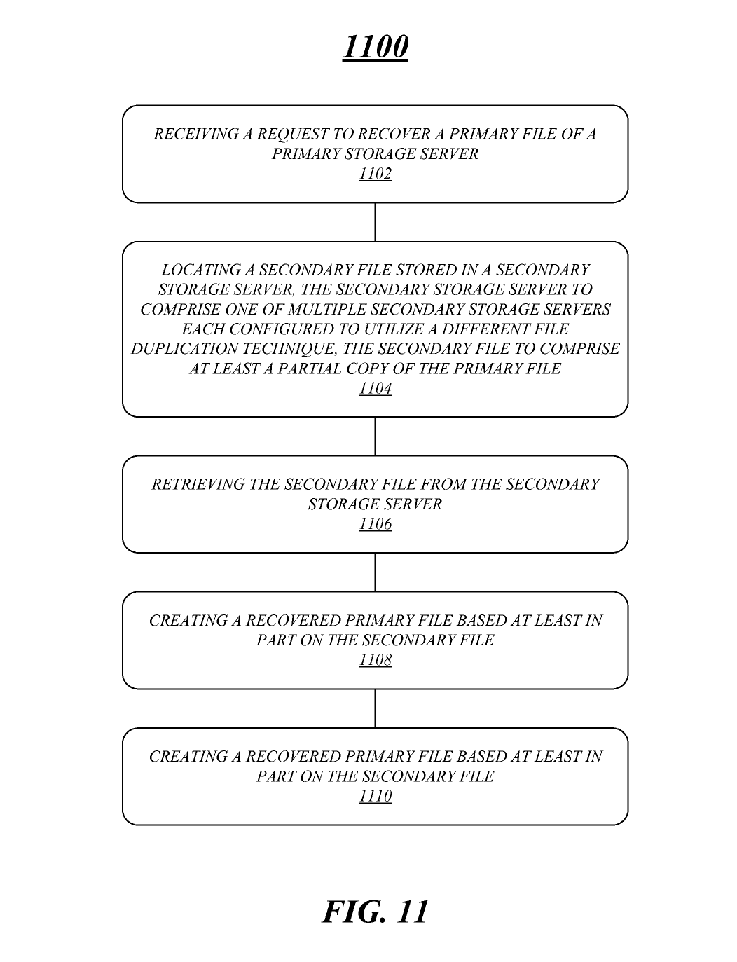

FIG. 11 illustrates one embodiment of a logic flow 1100. The logic flow 1100 may be representative of some or all of the operations executed by one or more embodiments described herein. For instance, the logic flow 110 may represent operations executed by the recovery manager application 120 of the apparatus 100.

In the illustrated embodiment shown in FIG. 11, the logic flow 1100 may receive a request to recover a primary file of a primary storage server at block 1102. For example, a recovery queue component 122-1 may receive a request to recover a primary file 110 of a primary storage server 602. The recovery queue component 122-1 may receive the request via monitoring the recovery queue 324 of the file sharing application 220, and retrieving a FRWI 326-c.

The logic flow 1100 may locate a secondary file stored in a secondary storage server, the secondary storage server to comprise one of multiple secondary storage servers each configured to utilize a different file duplication technique, the secondary file to comprise at least a partial copy of the primary file at block 1104. For example, the file location component 122-2 may locate a secondary file 130 stored in a secondary storage server 402-n, the secondary storage server 402-n to comprise one of multiple secondary storage servers 402-n each configured to utilize a different file duplication technique. For example, the file location component 122-2 may search for a secondary file 130 stored in one of secondary storage servers 402-1, 402-2 and 402-3 in series or parallel, with the secondary storage servers 402-1, 402-2 and 402-3 configured to utilize first, second and third file duplication techniques, respectively. The secondary file 130 may comprise at least a partial copy of the primary file 110.

The logic flow 1100 may retrieve the secondary file from the secondary storage server at block 1106. For example, the file recovery component 122-3 (or file location component 122-2) may retrieve the secondary file 130 from the secondary storage server 402-1 over a connection 410-1. The file recovery component 122-3 (or file location component 122-2) may retrieve the secondary file 130 from the secondary storage server 402-1 utilizing the location information 504 received via a Message 412.

The logic flow 1100 may create a recovered primary file based at least in part on the secondary file at block 1108. For example, the file recovery component 122-3 may create a recovered primary file 132 based at least in part on the secondary file 130. This may include renaming the secondary file 130 to a primary file filename 612 comprising part of the primary file metadata 112. This may further include modifying one or more permissions, properties, attributes or characteristics of the secondary file 130 to match corresponding permissions, properties, attributes or characteristics of the primary file 110. For instance, the secondary file 130 may comprise a read-only version of the primary file 110. In this case, the file recovery component 122-3 may change permissions for the secondary file 130 from read-only to read-write permissions. The file recovery component 122-3 may make other modifications to the secondary file 130 to create the recovered primary file 132 as necessary to match the recovered primary file 132 as closely as possible to the primary file 110.

The logic flow 1100 may send a file recovery notification for the recovered primary file at block 1110. For example, the file recovery component 122-3 may send the file recovery notification 726 for the recovered primary file 132. The file recovery notification 726 may include a recovery status parameter 728 and/or an error parameter 730. The recovery status parameter 728 may indicate success, partial success or failure of file recovery operations. The error parameter 730 may indicate any errors in the recovered primary file 132 relative to the deleted primary file 130, such as when the recovery status parameter 728 indicates only a partial success in creating the recovered primary file 132.

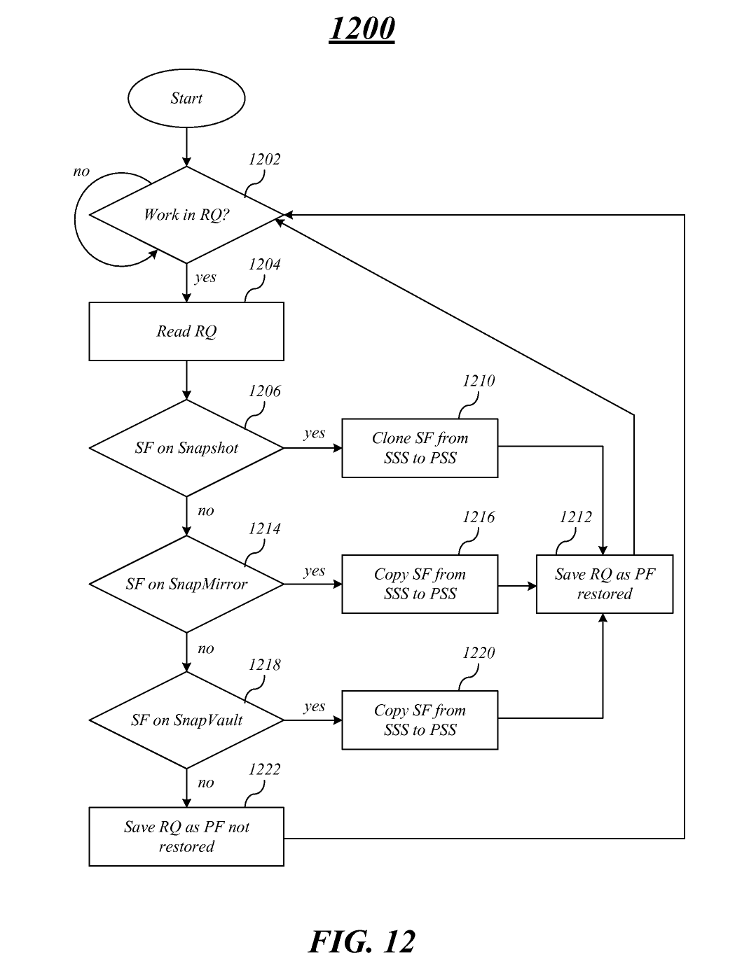

FIG. 12 illustrates one embodiment of a logic flow 1200. The logic flow 1200 may be representative of some or all of the operations executed by one or more embodiments described herein. For instance, the logic flow 1200 may represent an exemplary implementation for the recovery manager application 120.

In the illustrated embodiment shown in FIG. 12, the logic flow 1200 may monitor the recovery queue 324 until a FRWI 326-1 is found at block 1202. Once a FRWI 326-1 is found at block 1202, the recovery queue component 122-1 may issue a read request to read the FRWI 326-1 at block 1204. The FRWI 326-1 may request recovery of a primary file 110, and may include primary file metadata 112 for the primary file 110. The file location component 122-2 may initiate operations to locate a secondary file 130 for the deleted primary file 110. The file location component 122-2 may first search for the secondary file 130 on the secondary storage server 402-1 which uses a first file duplication technique, such as NetApp Snapshot, at block 1206. If the secondary file 130 is found on the secondary storage server 402-1, then the file recovery component 122-3 may clone the secondary file 130 to form a recovered primary file 132, and copy the recovered primary file 132 from the secondary storage server 402-1 to the primary storage server 602. The recovery queue component 122-1 may then send a file recovery notification 726 to update status of the FRWI 326-1 to indicate a successful or partially successful recovery of the primary file 110 at block 1212, and return control to block 1202 to wait for processing a next FRWI 326-2.

If the secondary file 130 is not found on the secondary storage server 402-1, then the file location component 122-2 may next search for the secondary file 130 on the secondary storage server 402-2 which uses a second file duplication technique, such as NetApp SnapMirror, at block 1214. If the secondary file 130 is found on the secondary storage server 402-2, then the file recovery component 122-3 may copy the secondary file 130 to form a recovered primary file 132, and store the recovered primary file 132 on the primary storage server 602, at block 1216. The recovery queue component 122-1 may then send a file recovery notification 726 to update status of the FRWI 326-1 to indicate a successful or partially successful recovery of the primary file 110 at block 1212, and return control to block 1202 to wait for processing a next FRWI 326-2.

If the secondary file 130 is not found on the secondary storage server 402-2, then the file location component 122-2 may next search for the secondary file 130 on the secondary storage server 402-3 which uses a third file duplication technique, such as NetApp SnapVault, at block 1218. If the secondary file 130 is found on the secondary storage server 402-3, then the file recovery component 122-3 may copy the secondary file 130 to form a recovered primary file 132, and store the recovered primary file 132 on the primary storage server 602, at block 1220. The recovery queue component 122-1 may then send a file recovery notification 726 to update status of the FRWI 326-1 at block 1212, and return control to block 1202 to wait for processing a next FRWI 326-2.

If the secondary file 130 is not found on the secondary storage server 402-3, then the file location component 122-2 may cease location operations, and the recovery queue component 122-1 may send a file recovery notification 726 to update status of the FRWI 326-1 to indicate a failure to recover the primary file 110 at block 1222, and return control to block 1202 to wait for processing a next FRWI 326-2.

FIG. 13 illustrates one embodiment of a logic flow 1300. The logic flow 1300 may be representative of some or all of the operations executed by one or more embodiments described herein. For instance, the logic flow 1300 may indicate operations of a file management application 220 and/or devices in the storage network 1000.

In the illustrated embodiment shown in FIG. 13, the logic flow 1300 may upload a primary file 110 to a primary storage server 602 at block 1302. For instance, a user may utilize a client device 1002-q to upload the primary file 110 at first point in time. At a second point in time later than the first point in time, the user may enter a user command into a client device 1002-q requesting deletion of the primary file 110 from the primary storage server 602 at block 1304. At a third point in time later than the second point in time, the user may enter a user command into a client device 1002-q requesting recovery of the primary file 110 deleted from the primary storage server 602 at block 1306.

The logic flow 1300 may initiate file recovery operations for the primary file 110 using the file management application 220 at block 1308. In one embodiment, the file recovery operations may be initiated automatically in response to the user command.

In one embodiment, the file recovery operations may be initiated manually in response to the user command, such as by a system administrator utilizing a web browser similar to web browser 914 implemented for the client device 910. The file management application 220 may create a FRWI 326-3 to request recovery of the primary file 110 at block 1310. The file management application 220 may store the FRWI 326-3 in the recovery queue 324 at block 1312.

The file management application 220 may monitor the recovery queue 324 to determine whether a recovery primary file 132 is created for the deleted primary file 110, as indicated by an updated recovery status for the FRWI 326-3 stored in the recovery queue 324, at block 1314. When the FRWI 326-3 is complete, the file management application 220 is notified of the recovered primary file 132 and its location in the primary storage server 602 at block 1316. The file management application 220 then updates the file system to indicate a presence of the recovered primary file 132 to the user at block 1318. The user may then download the recovered primary file 132 at block 1320 to a client device 1002-q.

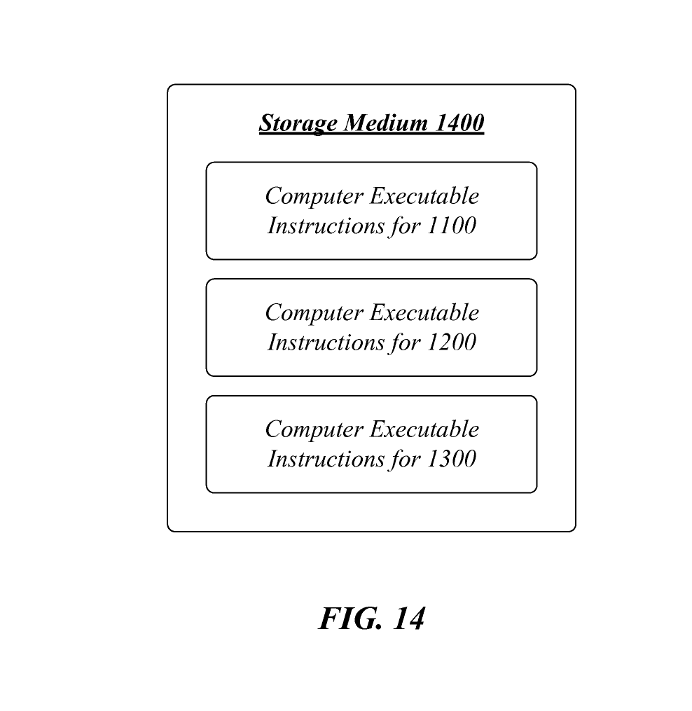

FIG. 14 illustrates an embodiment of a storage medium 1400. The storage medium 1400 may comprise an article of manufacture. In one embodiment, the storage medium 1400 may comprise any non-transitory computer readable medium or machine readable medium, such as an optical, magnetic or semiconductor storage. The storage medium may store various types of computer executable instructions, such as instructions to implement one or more of the logic flows 1100, 1200 and/or 1300. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The embodiments are not limited in this context.

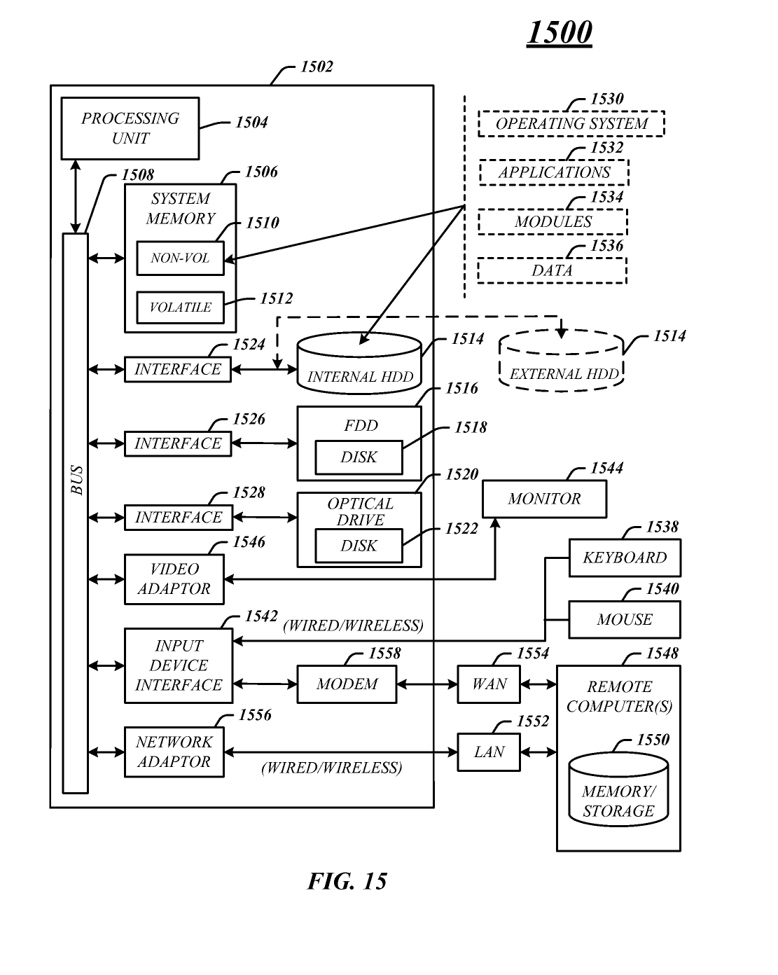

FIG. 15 illustrates an embodiment of an exemplary computing architecture 1500 suitable for implementing various embodiments as previously described. In one embodiment, the computing architecture 1500 may comprise or be implemented as part of an electronic device. Examples of an electronic device may include those described with reference to FIG. 8, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 1500. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1500 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1500.

As shown in FIG. 15, the computing architecture 1500 comprises a processing unit 1504, a system memory 1506 and a system bus 1508. The processing unit 1504 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1504.

The system bus 1508 provides an interface for system components including, but not limited to, the system memory 1506 to the processing unit 1504. The system bus 1508 can be any of several types of bus structure that may further interconnect to a memory bus (with or without a memory controller), a peripheral bus, and a local bus using any of a variety of commercially available bus architectures. Interface adapters may connect to the system bus 1508 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 1506 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 15, the system memory 1506 can include non-volatile memory 1510 and/or volatile memory 1512. A basic input/output system (BIOS) can be stored in the non-volatile memory 1510.

The computer 1502 may include various types of computer-readable storage media in the form of one or more lower speed memory units, including an internal (or external) hard disk drive (HDD) 1514, a magnetic floppy disk drive (FDD) 1516 to read from or write to a removable magnetic disk 1518, and an optical disk drive 1520 to read from or write to a removable optical disk 1522 (e.g., a CD-ROM or DVD). The HDD 1514, FDD 1516 and optical disk drive 1520 can be connected to the system bus 1508 by a HDD interface 1524, an FDD interface 1526 and an optical drive interface 1528, respectively. The HDD interface 1524 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1510, 1512, including an operating system 1530, one or more application programs 1532, other program modules 1534, and program data 1536. In one embodiment, the one or more application programs 1532, other program modules 1534, and program data 1536 can include, for example, the various applications and/or components of the apparatus 100.

A user can enter commands and information into the computer 1502 through one or more wire/wireless input devices, for example, a keyboard 1538 and a pointing device, such as a mouse 1540. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1504 through an input device interface 1542 that is coupled to the system bus 1508, but can be connected by other interfaces such as a parallel port, IEEE 1394 serial port, a game port, a USB port, an IR interface, and so forth.

A monitor 1544 or other type of display device is also connected to the system bus 1508 via an interface, such as a video adaptor 1546. The monitor 1544 may be internal or external to the computer 1502. In addition to the monitor 1544, a computer typically includes other peripheral output devices, such as speakers, printers, and so forth.

The computer 1502 may operate in a networked environment using logical connections via wire and/or wireless communications to one or more remote computers, such as a remote computer 1548. The remote computer 1548 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1550 is illustrated. The logical connections depicted include wire/wireless connectivity to a local area network (LAN) 1552 and/or larger networks, for example, a wide area network (WAN) 1554. Such LAN and WAN networking environments are commonplace in offices and companies, and facilitate enterprise-wide computer networks, such as intranets, all of which may connect to a global communications network, for example, the Internet.

When used in a LAN networking environment, the computer 1502 is connected to the LAN 1552 through a wire and/or wireless communication network interface or adaptor 1556. The adaptor 1556 can facilitate wire and/or wireless communications to the LAN 1552, which may also include a wireless access point disposed thereon for communicating with the wireless functionality of the adaptor 1556.

When used in a WAN networking environment, the computer 1502 can include a modem 1558, or is connected to a communications server on the WAN 1554, or has other means for establishing communications over the WAN 1554, such as by way of the Internet. The modem 1558, which can be internal or external and a wire and/or wireless device, connects to the system bus 1508 via the input device interface 1542. In a networked environment, program modules depicted relative to the computer 1502, or portions thereof, can be stored in the remote memory/storage device 1550. It will be appreciated that the network connections shown are exemplary and other means of establishing a communications link between the computers can be used.

The computer 1502 is operable to communicate with wire and wireless devices or entities using the IEEE 802 family of standards, such as wireless devices operatively disposed in wireless communication (e.g., IEEE 802.15 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.15x (a, b, g, n, etc.) to provide secure, reliable, fast wireless connectivity. A Wi-Fi network can be used to connect computers to each other, to the Internet, and to wire networks (which use IEEE 802.3-related media and functions).

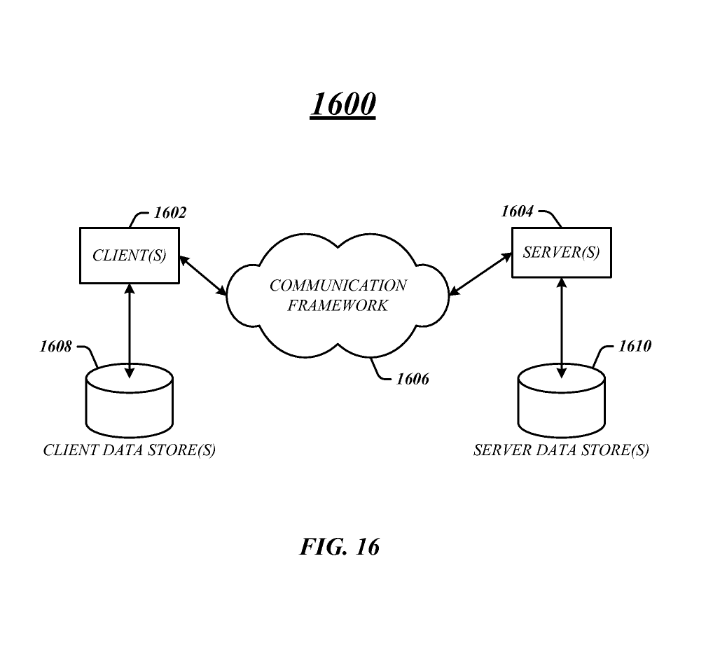

FIG. 16 illustrates a block diagram of an exemplary communications architecture 1600 suitable for implementing various embodiments as previously described. The communications architecture 1600 includes various common communications elements, such as a transmitter, receiver, transceiver, radio, network interface, baseband processor, antenna, amplifiers, filters, power supplies, and so forth. The embodiments, however, are not limited to implementation by the communications architecture 1600.

As shown in FIG. 16, the communications architecture 1600 comprises includes one or more clients 1602 and servers 1604. The clients 1602 may implement the client device 910. The servers 1604 may implement the server device 950. The clients 1602 and the servers 1604 are operatively connected to one or more respective client data stores 1608 and server data stores 1610 that can be employed to store information local to the respective clients 1602 and servers 1604, such as cookies and/or associated contextual information.

The clients 1602 and the servers 1604 may communicate information between each other using a communication framework 1606. The communications framework 1606 may implement any well-known communications techniques and protocols. The communications framework 1606 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1606 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1602 and the servers 1604. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus, comprising:
a processor circuit; and
a recovery manager application for execution on the processor circuit to manage file recovery operations for a file sharing application, the recovery manager application to comprise:
a recovery queue component to receive a request to recover a primary file deleted from a primary storage server;
a file location component to locate a secondary file stored in a secondary storage server, the secondary storage server to comprise one of multiple secondary storage servers each configured to utilize a different file duplication technique, the secondary file to comprise a copy of the primary file; and
a file recovery component to retrieve the secondary file from the secondary storage server, and create a recovered primary file based at least in part on the secondary file.

2. The apparatus of claim 1, the recovery manager application to comprise a recovery queue interface component to communicate with the file sharing application using a programmatic interface for a request-response message system.

3. The apparatus of claim 1, the recovery manager application to comprise a recovery queue interface component to communicate with the file sharing application using a representational state transfer (REST) interface to communicate REST messages.

4. The apparatus of claim 1, the recovery queue component to monitor a recovery queue of the file sharing application, and detect when a file recovery work item is stored in the recovery queue, the file recovery work item to represent the request to recover a primary file deleted from a primary storage server.

5. The apparatus of claim 1, the recovery queue component to retrieve a file recovery work item from a recovery queue of the file sharing application, the recovery work item to comprise primary file metadata for the deleted primary file, the metadata to include a filename for the deleted primary file.

6. The apparatus of claim 1, the file location component to search each of the multiple secondary storage servers for the secondary file based on a type of file duplication technique used to store the secondary file, and retrieve location information for the secondary file once the secondary storage server with the stored secondary file is located.

7. The apparatus of claim 1, the file recovery component to retrieve the secondary file from the secondary storage server, and store the secondary file under a filename specified by a file recovery work item to create the recovered primary file.

8. The apparatus of claim 1, the recovery queue component to send a file recovery notification to update a file recovery work item in a recovery queue, the file recovery notification to include a recovery status parameter to indicate successful creation of the recovered primary file for the deleted primary file.

9. The apparatus of claim 1, the recovery queue component to send a file recovery notification to update a file recovery work item in a recovery queue, the file recovery notification to include an error parameter to indicate one or more errors in the recovered primary file for the deleted primary file.

10. The apparatus of claim 1, the recovery manager application and the file sharing application to execute on a same computing device.

11. The apparatus of claim 1, the recovery manager application and the file sharing application to execute on different computing devices.

12. The apparatus of claim 1, comprising a display, a keyboard, and a communications component.

13. A computer-implemented method, comprising:
receiving a request to recover a primary file of a primary storage server;
locating a secondary file stored in a secondary storage server, the secondary storage server to comprise one of multiple secondary storage servers each configured to utilize a different file duplication technique, the secondary file to comprise at least a partial copy of the primary file;
retrieving the secondary file from the secondary storage server;
creating a recovered primary file based at least in part on the secondary file; and
sending a file recovery notification for the recovered primary file.

14. The computer-implemented method of claim 13, comprising communicating with the file sharing application using a programmatic interface for a request-response message system.

15. The computer-implemented method of claim 13, comprising communicating with the file sharing application using a representational state transfer (REST) interface to communicate REST messages.

16. The computer-implemented method of claim 13, comprising:
monitoring a recovery queue of the file sharing application; and
detecting when a file recovery work item is stored in the recovery queue, the file recovery work item to represent the request to recover the primary file of the primary storage server.

17. The computer-implemented method of claim 13, comprising retrieving a file recovery work item from a recovery queue of the file sharing application, the recovery work item to comprise primary file metadata for the primary file, the metadata to include a filename for the primary file.

18. The computer-implemented method of claim 13, comprising:
searching each of the multiple secondary storage servers for the secondary file based on a type of file duplication technique used to store the secondary file; and
retrieving location information for the secondary file once the secondary storage server with the stored secondary file is located.

19. The computer-implemented method of claim 13, comprising:
retrieving the secondary file from the secondary storage server;
renaming the secondary file to a filename specified by a file recovery work item to create the recovered primary file; and
sending the recovered primary file to the primary storage server.

20. The computer-implemented method of claim 13, comprising sending the file recovery notification to update a file recovery work item in a recovery queue, the file recovery notification to include a recovery status parameter to indicate successful creation of the recovered primary file for the deleted primary file.

21. The computer-implemented method of claim 13, comprising sending the file recovery notification to update a file recovery work item in a recovery queue, the file recovery notification to include an error parameter to indicate one or more errors in the recovered primary file for the deleted primary file.

22. At least one computer-readable storage medium comprising instructions that, when executed, cause a system to:
receive a file recovery work item to request recovery of a primary file deleted from a primary storage server;
locate a secondary file stored in a secondary storage server, the secondary storage server to comprise one of multiple secondary storage servers each configured to utilize a different file duplication technique, the secondary file to comprise at least a partial copy of the primary file;
retrieve the secondary file from the secondary storage server; and
create a recovered primary file based at least in part on the secondary file.

23. The computer-readable storage medium of claim 22, comprising instructions that when executed cause the system to communicate with the file sharing application using a programmatic interface for a request-response message system.

24. The computer-readable storage medium of claim 22, comprising instructions that when executed cause the system to communicate with the file sharing application using a representational state transfer (REST) interface to communicate REST messages.

25. The computer-readable storage medium of claim 22, comprising instructions that when executed cause the system to
monitor a recovery queue of the file sharing application; and
detect when a file recovery work item is stored in the recovery queue, the file recovery work item to represent the request to recover the primary file of the primary storage server.

26. The computer-readable storage medium of claim 22, comprising instructions that when executed cause the system to retrieve a file recovery work item from a recovery queue of the file sharing application, the recovery work item to comprise primary file metadata for the primary file, the metadata to include a filename for the primary file.

27. The computer-readable storage medium of claim 22, comprising instructions that when executed cause the system to
search each of the multiple secondary storage servers for the secondary file based on a type of file duplication technique used to store the secondary file; and
retrieve location information for the secondary file once the secondary storage server with the stored secondary file is located.

28. The computer-readable storage medium of claim 22, comprising instructions that when executed cause the system to
retrieve the secondary file from the secondary storage server;
rename the secondary file to a filename specified by a file recovery work item to create the recovered primary file; and
send the recovered primary file to the primary storage server.

29. The computer-readable storage medium of claim 22, comprising instructions that when executed cause the system to send a file recovery notification to update a file recovery work item in a recovery queue, the file recovery notification to include a recovery status parameter to indicate successful creation of the recovered primary file for the deleted primary file.

30. The computer-readable storage medium of claim 22, comprising instructions that when executed cause the system to send a file recovery notification to update a file recovery work item in a recovery queue, the file recovery notification to include an error parameter to indicate one or more errors in the recovered primary file for the deleted primary file.

31. An apparatus, comprising:
a recovery manager application for execution on circuitry to manage file recovery operations for a file sharing application, the recovery manager application to comprise:
a recovery queue component to monitor a recovery queue of the file sharing application, and detect when a file recovery work item is stored in the recovery queue, the file recovery work item to represent a request to recover a primary file deleted from a primary storage server;
a file location component to locate a secondary file stored in a secondary storage server, the secondary storage server to comprise one of multiple secondary storage servers each configured to utilize a different file duplication technique, the secondary file to comprise a copy of the primary file;
a file recovery component to retrieve the secondary file from the secondary storage server, and create a recovered primary file based at least in part on the secondary file; and
a recovery queue interface component to communicate with the file sharing application using a representational state transfer (REST) messages.

32. The apparatus of claim 31, the recovery queue component to send a file recovery notification to update a file recovery work item in a recovery queue using the recovery queue interface component, the file recovery notification to include a recovery status parameter to indicate successful creation of the recovered primary file for the deleted primary file.

33. The apparatus of claim 31, the recovery queue component to send a file recovery notification to update a file recovery work item in a recovery queue using the recovery queue interface component, the file recovery notification to include an error parameter to indicate one or more errors in the recovered primary file for the deleted primary file.
